(19) United States
(12) Patent Application Publication
(10) Pub. No.: US 2015/0302161 A1
(43) Pub. Date: Oct. 22, 2015

(54) SYSTSEM FOR MONITORING A USER

(71) Applicant: KONINKLIJKE PHILIPS N.V., AE Eindhoven (NL)

(72) Inventors: Marieke VAN DOOREN, Arendonk (BE); Jan TATOUSEK, Eindhoven (NL); Paul Anthony SHRUBSOLE, Arnhem (NL); Joyca Petra Wilma LACROIX, Eindhoven (NL); Joris Hendrik JANSSEN, Eindhoven (NL)

(21) Appl. No.: 14/648,731

(22) PCT Filed: Dec. 19, 2013
(86) PCT No.: PCT/EP2013/077268

§ 371 Date: Jun. 1, 2015

(30) Foreign Application Priority Data
Dec. 20, 2012 (EP) 12198527.9

(51) Int. Cl. G06F 19/00; G06F 17/30

(52) U.S. Cl. CPC G06F 19/3418; G06F 17/30595; G06F 17/30554; G06F 17/30312

(57) ABSTRACT

A system for monitoring a user is provided that stores user information about a psychological profile of the user, and a list of monitoring parameters that each comprise a measurable parameter related to the user. A tailored list of monitoring parameters is selected from the set of monitoring parameters based on the user information, and the system then monitors the user using the tailored list of monitoring parameters to provide monitoring results. Information related to the monitoring results can then be outputted to the user.

### FIELD OF THE INVENTION

The present invention relates to a system and method for monitoring a user, particularly in relation to monitoring the health condition of the user and/or the user's adherence to a therapeutic regime.

### BACKGROUND OF THE INVENTION

There are many illnesses that require long term management. For example, a patient with a long term health condition may have a therapeutic regime prescribed by a doctor, that the patient should then adhere to. The therapeutic regime may manage the patient's symptoms, and the objective of the therapeutic regime is to manage the patient's condition and to help to achieve a positive therapy outcome. It will be appreciated that non-adherence with the therapeutic regime may cause the patient's health to deteriorate.

Alternatively, a patient with a long term health condition may not require an active therapeutic regime. For such patients, it may be necessary to monitor the patient's symptoms, taking appropriate medical action if the patient's symptoms worsen.

An example of a chronic disease cycle is provided in FIG. 1. Such a pattern is common to many long term health conditions.

For a patient with such a long term health condition, assuming that an outright cure is not possible, stability S1 represents the most positive outcome for the patient. When the patient is stable, the patient's symptoms may fluctuate from day to day, but there is no downward trend. Maintaining stability is likely to be the goal of a therapeutic regime aimed at managing a long term health condition.

If the patient's condition worsens (see path P1), there may be an event onset S2. The term “event onset” refers to a moment when the patient becomes unstable, but not yet acute (that is the next state on the circle). The event could be triggered by the patient contracting another illness (e.g. a cold) or by some other cause that worsens the patient's condition. The event might typically be the first signs of the patient's worsening condition manifesting themselves. The event refers here to the unstable state, which requires some intervention to bring the patient back into a stable state. Such intervention can be change of the patient's medication, ambulatory intervention of the physician or in the worst case hospitalization.

After the event onset S2, if the patient's condition is properly managed (e.g. a corrective action is taken), then the patient's condition may improve and the patient might go back to the stability phase S1, via path P2. However, if the patient's condition is not properly managed and/or the patient's symptoms worsen, then the patient may need to be admitted to hospital S3 via path P3. In general terms, the aim of an admission to hospital S3 is to discharge the patient S4 (via path P4) as soon as possible (i.e. to minimise inpatient treatment). After that recovery continues in the recovery step S5 (via path P5), with the aim of the patient becoming stable again (via path P6). Hence, it is desirable to identify the event soon after its onset, because it is likely that as more time that passes, more expensive interventions will have to be used to bring the patient back to the stable state.

Hence, the patient's long term health condition can be visualised in terms of two loops. The first loop involves stability S1 moving to onset S2, and then back to stability S1. This first loop represents an ideal management of an event of instability for a patient with a long term health condition. The second loop involves admission S3, discharge S4 and recovery S5 after the onset. In terms of the drain on resources on a health care system, typically the costs associated with admitting a patient to hospital dwarf the costs associated with maintaining stability.

It is known to provide devices for monitoring aspects of a user's health. One such system is discussed in WO2008/002525. This attempts to provide a system that monitors changes in the wellness of a patient. In practice the effectiveness of such systems is low. Many users do not like to be actively monitored, and such devices require the consent and compliance of the user. If the user is minded not to use the monitoring system, then the monitoring system will be ineffective.

### SUMMARY OF THE INVENTION

It is an object of the invention to provide a system for monitoring a user which substantially alleviates or overcomes the problems mentioned above. In particular, it is an object of the invention to provide a system for monitoring a user that overcomes the technical shortcomings of known monitoring systems.

According to an aspect of the present invention, there is provided a system for monitoring a user, the system comprising: a user database arranged to store user information about a psychological profile of the user; a monitoring database arranged to store a set of monitoring parameters, each monitoring parameter comprising a measurable parameter related to the user; a selection processor arranged to select a tailored list of monitoring parameters from the set of monitoring parameters based on the user information; a monitor mechanism arranged to monitor the user using the tailored list of monitoring parameters to provide monitoring results; an output mechanism arranged to output information related to the monitoring results.

This arrangement provides the advantage that the monitoring of the user (e.g. monitoring the health of the user or the user's adherence to a medication regime) is done using monitoring parameters that are compatible with and appropriate for the psychological profile of the user. People can be categorised according to their psychological profile, with different people responding better or worse to the same means of monitoring them.

The relevance of a specific monitoring parameter varies from users. Due to this variation, known systems to monitor the health or wellbeing of the user are not particularly effective.

By tailoring the monitoring of the user according to the user's psychological profile, the effectiveness of the monitoring system is greatly increased when compared to known systems. Known systems do not take into account compatibility with the patient's psychological profile. In other words, known systems do not take into account the acceptability by the patient. If an incompatible system is used, there is a high likelihood, that the patient will not use it at all, will stop using it after a certain period of time or will use it in a way that significantly reduces effectiveness of the system. Such a use of the system not a meaningful use of resources and shall be avoided.

In order to overcome the above mentioned problems, the above system provides a tailored solution to increase the effectiveness of monitoring the user. By monitoring the user more effectively, it is possible to increase the chances of a patient with a long term health condition being stable, and to detect an onset of instability as early as possible.

In some embodiments, the user information comprises information relating to which of a predetermined number of psychological profiles the user belongs to, with each said psychological profile being differently responsive to certain monitoring parameters. For example, in some embodiments users may be categorised into one of four profiles, with each profile corresponding to a personality type. Categorising users into psychological profiles in this way represents a convenient and efficient way of determining information relating to the user's psychological profile. It has been found that having four is a compromise between complexity of tailoring and effectiveness.

In some embodiments, the output mechanism is arranged to display information used in the monitoring of the user using the tailored list of monitoring parameters. For example, the output mechanism could display information to the user regarding the monitoring parameters during monitoring, and/or output mechanism could display information relating to the results of the monitoring.

In some embodiments, the output mechanism is arranged to display feedback to the user regarding the results of the monitoring. By doing this, the system can involve the user in the process, which is particular important in embodiments where the user's behaviour (e.g. compliance to a therapeutic regime) is important.

In some embodiments, the output mechanism is arranged to select the appropriate information to display based on the user information. In some embodiments, the output mechanism is arranged to tailor how to display the information to the user based on the user information. Hence, in such embodiments, the form and/or content of the information display to the user is varied according to the user's psychological profile. For example, user's with certain profile types response better to certain types of information and/or certain ways of displaying information in a more positive way that other types of information and/or ways of displaying information.

By doing this the user is provided with information in a form and/or content that they are comfortable with, greatly enhancing the usability and user experience of the system. As a result, the user is more likely to understand the information and interpret it correctly, and is more likely to find information motivating. The user is also less likely to find the information discouraging, and less likely to feel threatened by the information.

It has been found that offering tailored health-related information in as little as four profiles accommodating the psychological characteristics of users makes a big difference in how people perceive and are touched by the information. Users show a strong preference for documents tailored to their profile compared to generic documents or the ones tailored to other profiles (i.e. not their own).

In some embodiments, the monitor mechanism is arranged to monitor the user's adherence with a therapeutic regime using the tailored list of monitoring parameters, wherein the output mechanism is arranged to display feedback to the user to aid the user's adherence with the therapeutic regime. By doing this, such embodiments can help a user with a long term health condition that requires adherence to a therapeutic regime to maintain stability.

In some embodiments, the monitor mechanism is arranged to determine an adherence evaluation result relating to the user's adherence with the therapeutic regime based on the monitoring results, and to determine based on a comparison of the adherence evaluation result compared to a stored adherence evaluation result threshold whether there has been a deterioration in the adherence of the user to the therapeutic regime over a predetermined threshold.

In some embodiments, if there has been a deterioration in the adherence of the user to the therapeutic regime over the predetermined threshold, the output mechanism is arranged to provide an adherence alert that there has been such a deterioration in the adherence of the user to the therapeutic regime. The adherence alert could be provided to the user or to a carer or other health care professional. In some embodiments, the output mechanism is arranged to tailor the adherence alert based on the user information.

In some embodiments, the system further comprises an evaluation mechanism arranged to determine an evaluation result relating to the health of the user based on the monitoring results, and to determine based on a comparison of the evaluation result compared to a stored evaluation result threshold whether there has been a deterioration in the health of the patient over a predetermined threshold. By doing this, such embodiments can help detect when a user with a long term health condition may be experiencing an onset of instability.

In some embodiments, if there has been a deterioration in the health of the patient over the predetermined threshold, the output mechanism is arranged to provide an alert that there has been such a deterioration. The alert could be provided to the user or to a carer or other health care professional. In some embodiments, the output mechanism is arranged to tailor the alert based on the user information.

In some embodiments, the user information further comprises information relating to additional information about the user, and wherein the selection processor is arranged to select a tailored list of monitoring parameters from the set of monitoring parameters taking into account said additional information about the user. In such embodiments, the system could determine additional characteristics associated with the user in addition to the user's profile. For example, the system may determine (e.g. via a questionnaire) the gender, and age, and family situation (i.e. with children, without children) of the user. These additional profiling characteristics could then be used with the user's profile type in order to improve the monitoring of the user. In addition, in some embodiments, the system can determine based on the profile which additional information is needed. Such additional information could also be used to tailor the form and/or content of information displayed by the output means.

In some embodiments, the system can be provided on a single device. In other embodiments, various components of the system can be distributed among two or more devices.

According to another aspect of the invention, there is provided a method for monitoring a user, the method comprising: storing user information about a psychological profile of the user; storing a set of monitoring parameters, each monitoring parameter comprising a measurable parameter related to the user; selecting a tailored list of monitoring parameters from the set of monitoring parameters based on the user information; monitoring the user using the tailored list of monitoring parameters to provide monitoring results; and outputting information related to the monitoring results.

These and other aspects of the invention will be apparent from and elucidated with reference to the embodiments described hereinafter.

### BRIEF DESCRIPTION OF THE DRAWINGS

Embodiments of the invention will now be described, by way of example only, with reference to the accompanying drawings, in which:

FIG. 1 shows a schematic of a cycle of patient condition and treatment states during the chronic disease;

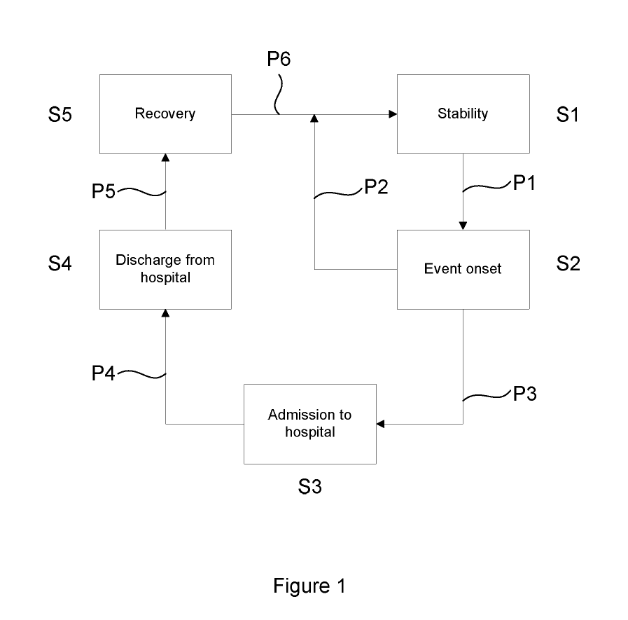

FIG. 2 schematically shows a system for monitoring a user according to a first embodiment of the invention;

FIG. 3 shows a flow diagram explaining the operation of the system of the first embodiment;

FIG. 4 shows a flow diagram explaining the process for determining for the psychological profile of a user of system of the first embodiment;

FIG. 5 schematically shows a system for monitoring a user according to a second embodiment of the invention;

FIG. 6 shows a flow diagram explaining the operation of the system according to the second embodiment;

FIG. 7 shows a flow diagram explaining the operation of the system according to a third embodiment;

FIG. 8 schematically shows a system for monitoring a user according to a fourth embodiment of the invention; and

FIG. 9 shows a flow diagram explaining the operation of the system according to the fourth embodiment.

### DETAILED DESCRIPTION

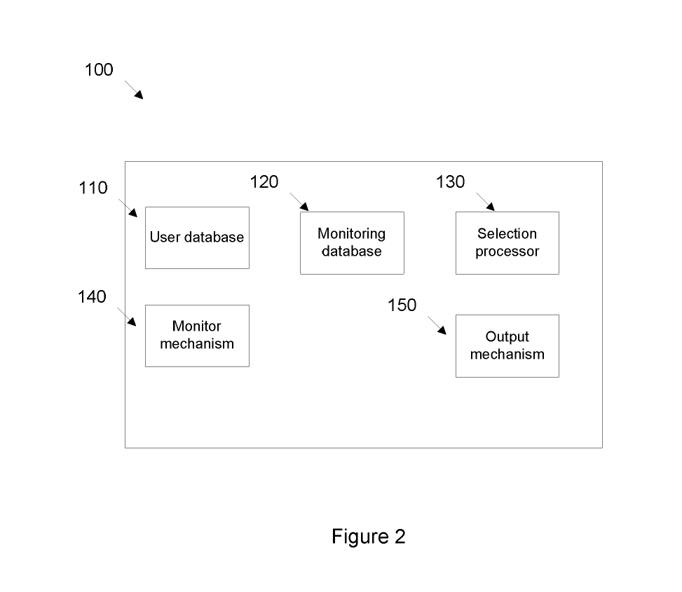

FIG. 2 schematically shows a system 100 for monitoring a user according to a first embodiment of the invention. In this embodiment the system could be used by a user (e.g. a patient with a long term health condition) or a carer of the user.

The system 100 comprises a user database 110, a monitoring database 120, a selection processor 130, a monitor mechanism 140, and an output mechanism 150.

The user database 110 is arranged to store user information about a psychological profile of the user. In this embodiment, as will be discussed in more detail below, the user information comprises information relating to which of a predetermined number of psychological profiles the user belongs to, with each said psychological profile being differently responsive to certain monitoring and feedback or output parameters.

The monitoring database 120 is arranged to store a set of monitoring parameters, each monitoring parameter comprising a measurable parameter related to the user. In this embodiment, each monitoring parameter comprises a measurable parameter that is related to the health condition of the user. A non-exhaustive list of monitoring parameters suitable for this and other embodiments of the invention is provided below.

The selection processor 130 is arranged to select a tailored list of monitoring parameters from the set of monitoring parameters based on the user information. In other words, the selection processor 130 is arranged to select those monitoring parameters that are suitable for the user, based on the psychological profile of the user. In this embodiment, users are categorised into one of a predetermined number of psychological profiles, and the selection processor 130 will select those monitoring parameters that are most suitable for the user's psychological profile.

The monitor mechanism 140 is arranged to monitor the user using the tailored list of monitoring parameters to provide monitoring results. In other words, once the selection processor 130 has selected the monitoring parameters that are suitable for the user, based on the psychological profile of the user, the user can be monitored by the monitor mechanism 140.

The output mechanism 150 is arranged to output information related to the monitoring results. In this embodiment, the output mechanism 150 is arranged to display feedback to the user regarding the results of the monitoring. Hence, in this embodiment, the output mechanism 150 comprises a display. In this embodiment, the output mechanism is arranged to select the appropriate information to display based on the user information. In this embodiment, the output mechanism is also arranged to tailor how the information is displayed to the user based on the user information

Hence, in such embodiments, the form and content of the information display to the user is varied according to the user's psychological profile. By doing this the user is provided with information in a form and content that they are comfortable with, greatly enhancing the usability of the system and also the user experience and effectiveness. Users show a strong preference for documents tailored to their profile compared to generic documents or the ones tailored to other profiles (i.e. not their own).

In this embodiment, the output mechanism 150 is also arranged to display information used in the monitoring of the user using the tailored list of monitoring parameters. The output mechanism 150 displays information to the user regarding the monitoring parameters during monitoring. The form and content of this information can be tailored according to the user's profile.

In this embodiment, the user database 110, monitoring database 120, selection processor 130, monitor mechanism 140 and output mechanism 150 are provided on the same apparatus. For example, such an apparatus could be a smart phone, tablet, general purpose computer or other suitable apparatus. In other embodiments, the apparatus may communicate with external additional monitoring mechanisms. Also, in other embodiments, the elements of the system could be provided on different devices.

In some embodiments, the monitor mechanism 140 can have local components distributed across several devices. Those could either communicate with a local control unit (represented by one of the monitoring devices or by a separate device) or with a remote system or both of these approaches can be combined in one system. In some embodiments, the monitor mechanism 140 can have a form of a remote system (e.g. web server) accessed by the user using a local terminal (e.g. computer, smartphone, tablet etc), for instance for questionnaire based user monitoring.

In some embodiments, the monitor mechanism 140 can be in the same device as the output mechanism 150 or in separate devices (i.e. one device monitors the parameter and another device displays it).

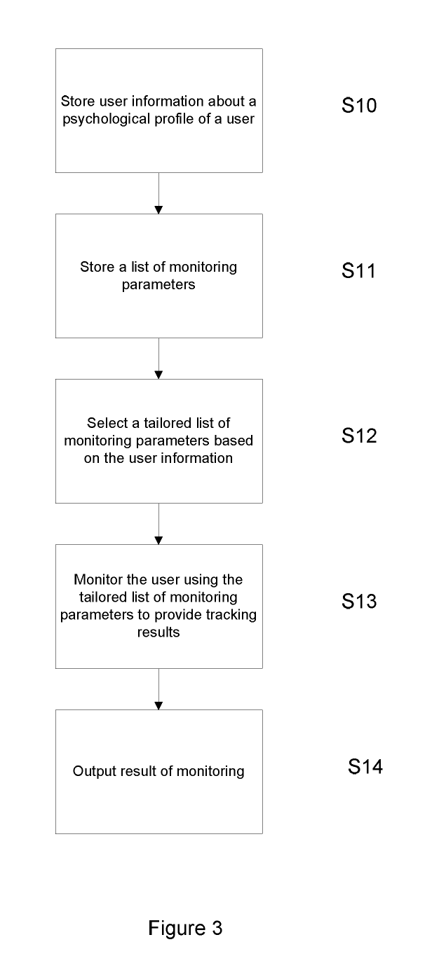

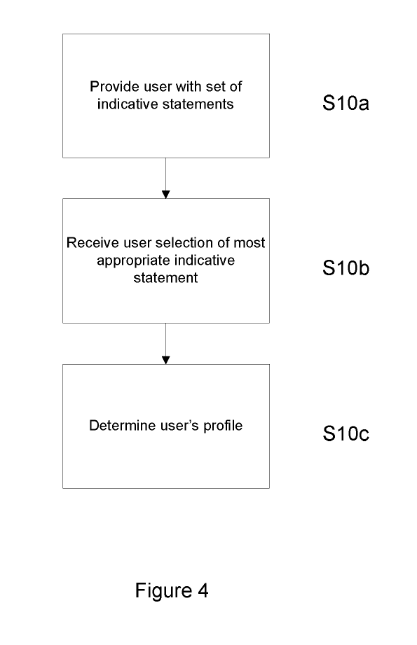

FIG. 3 shows a flow diagram explaining the operation of the system 100, and FIG. 4 shows a flow diagram showing how the user information is obtained in this embodiment.

In step S10 of FIG. 3, the system 100 stores user information about a psychological profile of a user in the user database 110. In this embodiment, the system 100 determines the content of user information using a user input.

In some embodiments, the systems request a certain input from the user (answers to questions, choice from options, etc) and uses a classification algorithm to determine user's psychological profile. Based on the determined psychological profile, the system may use another algorithm to determine which additional input to ask from the user in order to obtain a sufficient set of user information required for tailoring to the psychological profile of the user.

In this embodiment, users are categorised into one of a predetermined number of psychological profiles. An example process according to this embodiment of the invention for the system 100 determining which of the predetermined number of psychological profiles is shown in FIG. 4.

In this embodiment, users are classified into one of four psychological profiles, which will be labelled the “Analyst”, “Optimist”, “Sensitive” and “Fighter” profiles. Other embodiments could use a different number or selection of profiles, or could use other sorts of ways of categorising the psychological profile of the user.

In this embodiment, respective users with a long term health condition with the Analyst (P1), Optimist (P2), Fighter (P3), and Sensitive (P4) profiles have the following example characteristics:

P1 (Analyst): Such users are organised and want to know the ins and outs of their condition. Such users crave information about their condition. Such users typically like routines and often develop their own medication/health care regime. Such users are particularly receptive to objectively obtained facts and numbers to help them understand and manage their condition.

P2 (Optimist): Such users want to enjoy the simple things in life. They regard their health as important to them, but do not let their condition rule their life. They often view their medication (or other health procedures) as something that allows them to do the things that they enjoy. Such users are particularly receptive to their own and others' subjective experiences to help them understand and cope with their condition.

P3 (Fighter): Such users are confident, self-reliant, likes to feel in control. They will typically do whatever they have to do to manage their condition. They often view their medication (or other health procedures) as something that helps them fight their condition. Such users are particularly receptive to objective information regarding the recommended actions to take and the expected gains/outcomes.

P4 (Sensitive): Such users do not need or want to know the details regarding their condition. They are often disappointed with the results their medication provides. They have typically low self-efficacy concerning the routine and need regular reassurance. Such users are particularly receptive to a guiding helping hand from a carer that they can fully trust and rely on to help them cope with their condition.

This characteristics represent generalisations of user information related to the psychological profile of the user, and are provided for ease of illustration. Other embodiments can use other profile types. That said, recently obtained preliminary data illustrates that offering tailored health-related information in as little as four profiles accommodating the psychological characteristics of people makes a big difference in how people perceive and are touched by the information. As discussed below, categorising users into one of these four profile types has led to good experimental results in trials of embodiments of the invention. In experiments, patients showed strong preference of documents tailored to their profile compared to generic documents or the ones tailored to other profiles.

In order to characterise a user into one of the above four profile types, as shown in step S10a, in this embodiment, the user is provided with four phrases and asked to pick the statement that best represents them. An example of a set of statements suitable for use in this embodiment for users with a long term health condition is set out below:

Statement 1: “I need to know about my condition, so that I can make the right decisions about my treatment”

Statement 2: “I especially want to enjoy life, which sometimes allows me to forget that treatment is also part of my life”

Statement 3: “I just want to know what to do and I will do it as long as it brings improvements quickly”

Statement 4: “With my condition, the only thing I can do is trust my physician in offering me the best care and medicines”

In this example, Statement 1 is associated with the P1 (Analyst) profile, Statement 2 is associated with the P2 (Optimist) profile, Statement 3 is associated with the P3 (Fighter) profile, and Statement 4 is associated with the P4 (Sensitive) profile.

In step S10a, the user is presented with these four statements, and in step S10b, the user selects which of these statements best represents him. The user can make the selection using any appropriate input device on the system 100, for example a touch screen on a smartphone.

Once the system 100 has received the user selection of the most appropriate statement, the system 100 determines the user's profile at step S10c. In this embodiment, the step of determining the user's profile comprises matching the user selection of the most appropriate indicative phrase. However, in other embodiments that use a more detailed assessment of the user's psychological profile, the step of determining the user's profile may involve a number of other processes. For example, if the user's psychological profile involved the use of a questionnaire, then the step of determining the user's profile may involve analysing the questionnaire results and applying suitable weightings to each answer so as to arrive at the user's profile.

Once the user's profile is determined in step S10c, the user's profile is stored as the user information about the psychological profile of the user in step S10 of FIG. 3.

In other embodiments, the user information can also comprise other information. For example, the system 100 could determine additional characteristics associated with the user in addition to the user's profile. For example, the system 100 may determine (e.g. via a questionnaire) the gender, and age, and family situation (i.e. with children, without children) of the user. These additional profiling characteristics could then be used with the user's profile type in order to improve the monitoring of the user. In addition, in some embodiments, the system can determine based on the profile which additional information is needed. For instance the gender could be requested only from the P4 (Sensitive) and P2 (Optimist) profiles, and the family situation only from the P2 (Optimist) profile.

Furthermore, in some embodiments, the user information can comprise information relating to the medical history of the patient. This could be determined via a questionnaire or by receiving information directly from a health care professional.

At step S11, the system 100 stores a list of monitoring parameters. It will be appreciated that although step S11 is shown after S10, this is purely for convenience of illustration. The system 100 could store the list of monitoring parameters before, after or simultaneously as it stores the user information about a psychological profile of a user. For example, both the list of monitoring parameters and the user information could be sent to the system 100 at the same time by a system belonging to a health care professional (or suitable server).

In embodiments of the invention, the list of monitoring parameters stored by the system 100 can comprise all the relevant monitoring parameters relevant to the user's specific long term health condition (specific examples of which are provided below). For example, the system 100 could be sent the list of monitoring parameters relevant to the user's specific long term health condition by a system belonging to a health care professional (or suitable server), with the system belonging to the health care professional storing a master list of all possible monitoring parameters employable by the system 100. Alternatively, the system 100 itself could comprise the master list of all possible monitoring parameters employable by the system 100.

At step S12, the selection processor 130 of the system 100 selects a tailored list of monitoring parameters based on the user information. This could be done on the basis of a look up table.

At step S13, the monitor mechanism 140 of system 100 monitors the user using the tailored list of monitoring parameters to provide monitoring results, and at step S14, the output mechanism 150 of system 100 outputs the results of monitoring.

To help explain steps S12 and S13, a number of example monitoring parameters related to aspects of the health of the user and/or the user's adherence with a therapeutic regime will be discussed.

It will be appreciated that some of these example monitoring parameters are generally applicable to monitoring the health of the user, while others (e.g. dyspnea) are more specific and may apply to only some conditions. Furthermore, as discussed below, some monitoring parameters may have more than one monitoring method. For example, some monitoring parameters can have an obtrusively monitoring method and an unobtrusively monitoring method. Furthermore, some monitoring parameters could have variants that are subjectively monitored as well as variants that are objectively monitored. For the avoidance of doubt, it will be appreciated that whether one way of monitoring is considered obtrusive or unobtrusive is somewhat subjective, as different users (and different profile types) may have different thresholds as to what is considered obtrusive to them. Hence, where a particular method is described as “obtrusive” or “unobtrusive”, it will be appreciated that this is just a guide for ease of illustration.

The different monitoring parameters may be monitored in different ways, because users with different personality types vary greatly in their responses to different ways of monitoring them. Hence, once the selection processor 130 of the system 100 selects a tailored list of monitoring parameters based on the user information, the monitor mechanism 140 will track each monitoring parameter in the appropriate way based on the user's psychological profile. By tailoring the monitoring of the user according to the user's psychological profile, the effectiveness of the monitoring system is greatly increased when compared to known systems. By monitoring the user more effectively, it is possible to detect an onset of instability as early as possible and to take corrective action, thereby increasing the chances of a patient with a long term health condition to remain stable.

As an example, one monitoring parameter could be related to dyspnea, which is the symptom of being short of breath. Dyspnea can be tracked subjectively, relying on information provided by the user. The subjective monitoring could be done via a user questionnaire or the user using a slide bar (or other appropriate user interface) to indicate their perceived level of shortness of breath.

Dyspnea could also be tracked objectively, using a suitable audio monitoring system that detected the amount and type (e.g. laboured or not laboured) of the user's breathing. Such objective monitoring could be done obtrusively (e.g. the user wearing a suitable audio monitoring system) or unobtrusively (e.g. using the existing microphone in a smartphone).

Another example of monitoring parameter is blood pressure. Blood pressure must be tracked objectively, using a suitable blood pressure monitor. In embodiments of the invention that use a smartphone (or other such device), it would be necessary for the system to communicate with an external monitoring device to monitor blood pressure, which would be an obtrusive measurement. The obtrusiveness of this measurement is based on the fact that it takes time, required a special procedure with a device. In addition, the measurement is not very comfortable, and the user may feel uncomfortable to do it in public.

Some monitoring parameters are purely subjective, such as the user's perceived tiredness level. Though it is noted that drowsiness can be, however, also measured objectively and unobtrusively, e.g. via the video monitoring of blinking and opening of eye lids used in the automotive applications. The user's perceived tiredness level needs to be tracked based on information provided by the user. This subjective monitoring could be done via a user questionnaire or the user using a slide bar (or other appropriate user interface) to indicate their perceived level of tiredness.

For subjective monitoring parameters, the monitoring can be performed using questions or prompts for the user. Furthermore, for some monitoring parameters, there may be well known monitoring metrics that embodiments of the invention could use. For example, for the monitoring parameter measuring the user's quality of life, the system could use standard EQ5D measures.

Other monitoring parameters relate to specific activities of a user. For example, the system 100 could track whether the user has taken their medication. This could be monitored using a suitable medication dispenser, with a suitable sensor that indicates whether the user has received the medication. The medication dispenser could be part of the system 100 or be in communication with the system 100.

In addition, the system 100 could track whether the user has performed a prescribed exercise. This could be done subjectively, with the user providing an indication (via a user questionnaire or similar) that they feel that have done “enough” of their exercise for that day. It could also be tracked objectively in an obtrusive way, with the user or care provider indicating that the user has done all of the required exercises for the day. Furthermore, it could be tracked objectively in an unobtrusive way, e.g. using a GPS sensor in a smartphone or similar device to see if a certain amount of physical exercise (e g running) has been performed.

In other words, the form of the monitoring will depend on the monitoring parameters present in the user's tailored list. As discussed above, some monitoring parameters will be monitored based on the user's responses to prompts or questions, providing subjective data. Other monitoring parameters will be monitored by objective methods, e.g. using hardware present on the system 100 or an external monitoring mechanism in communication with the system 100. In other embodiments, the user could enter in the system a reading from an external measurement mechanism (e.g. blood sugar level meter, test pads). This will be also considered as objective. As a result, the monitor mechanism 140 will monitor the user in the appropriate way based on the tailored list of monitoring parameters.

TABLE 1
Examples of monitoring parameters

| Monitoring | Subjectively | Objectively monitor in an | Objectively monitor in an |
|---|---|---|---|
| Parameter | monitor? | obtrusive way? | unobtrusive way? |
| Dyspnea | Yes | Yes, e.g. via wearable audio | Yes, e.g. using microphone in a |
| | | monitor measuring breathing | smartphone or similar device |
| | | sounds | |
| Amount of | Yes | Yes, e.g. via wearable audio | Yes, e.g. using microphone in a |
| coughing | | monitor measuring coughing | smartphone or similar device |
| | | sounds (though not all wearable | |
| | | devices need be obtrusive) | |
| User's activity | Yes | Yes, e.g. via an external apparatus | Yes, e.g. using a GPS sensor in a |
| level | | measuring how far the user walks | smartphone or similar device |
| | | in a day (though not all such | to measure |
| | | devices need be obtrusive) | how far the user walks in a day |
| Oxygen saturation | No | Yes, e.g. via an external apparatus | No |
| (SpO2) | | | |
| User's weight | No | Yes, e.g. via an external apparatus | No |
| Blood pressure | No | Yes, e.g. via external apparatus | No |
| User's heart rate | No | Yes, e.g. via an external apparatus | Yes, e.g. via using a camera in a |
| | | | smartphone or similar device |
| Amount of gas | Yes | No | No |
| passed | | | |
| Blood in stool | Yes | Yes, via a test pad | No |
| Diarrhoea | Yes | No | No |
| User's feeling of | Yes | No | No |
| wellbeing | | | |
| User's quality of | Yes, e.g. using | No | No |
| life | EQ5D measures | | |
| User's perceived | Yes | No | No |
| pain level | | | |
| Medication | Yes | Yes | Yes, a medication dispenser could have a |
| taken? | | | suitable sensor that indicates whether the |
| | | | user has received the medication. |
| Prescribed | Yes, the user could | Yes, the user could indicate that | Yes, e.g. using a GPS sensor in a |
| exercise | indicate that they | they have done all of their | smartphone or similar device to see if a |
| performed? | have done | exercises. | certain amount of physical exercise (e.g. |
| | “enough” of their | | running) has been performed |
| | exercise. | | |

Referring to the example profile types mentioned above, a user with the P1 (Analyst) profile will appreciate monitoring that provides detailed vital signs and symptoms measuring and reporting with a clear link to the disease, so that the user can self-interpret (being trained to do so or supported by information provided by the system) what he is reporting. Such a user would typically have no problem with obtrusive monitoring, e.g. the one that takes time, or is not very comfortable. As an example, the system 100 could select for a user with the P1 (Analyst) profile a toolset of measurement devices (a small home lab), interpretation system, graphical visualization, what-if analysis and decision making tools.

A user with the P2 (Optimist) profile will appreciate monitoring that provides unobtrusive monitoring that the user does not have to spend any time on or that he can see only if he explicitly wants to. As an example, the system 100 could select monitoring parameters that provide unobtrusive activity monitoring wherever possible.

A user with the P3 (Fighter) profile will appreciate monitoring that monitors performance to an agreed goal, so that the user can clearly see his progress or a lack of progress, complemented with instructions how to keep on track. As an example, the system 100 could select for a user with the Fighter profile simple, not time consuming measurement with an easy to interpret indicator (one number), ideally performed during other activities (e.g. driving a car, exercising). The system 100 could provide simple tools, automatic, but patient triggered entry, and progress monitoring visualization.

A user with the P4 (Sensitive) profile will appreciate monitoring of therapy related behaviour, so that the user could see what he has done and how well he has done it. For the P4 (Sensitive) profile, the system 100 should focus on reassurance and stimulation to establishing a well mastered routine. As an example, the system 100 could include dispensing detection, electronic task lists, and a calendar of activities.

In general, for any appropriate long term health condition, it may be desirable to select as many monitoring parameters as possible that are appropriate for that condition. In known systems, the tendency is to pick all the relevant monitoring parameters and to track all users in the same way. However, as will now be appreciated, some forms of monitoring (e.g. routine based monitoring for a user with the Sensitive profile) will not be effective for users with other profiles. In fact, using a form of monitoring, that is not appropriate for the psychological profile of the user, is very likely to cause the user to ignore and therefore not use the system 100. The moment the user deliberately ignores one or more elements of the monitoring system, the effectiveness of the monitoring system will decrease rapidly. Such monitoring systems require user engagement. Without user engagement, the system will not be effective.

Some profiles (e.g. Analyst) do not have an adverse tendency towards objective monitoring. However, other profiles (e.g. Optimist) may not respond well to objective monitoring. For some parameters to be monitored (e.g. activity) it may be possible to track unobtrusively and obtrusively. For example, it is possible to monitor user's activity levels by a questionnaire, which is obtrusive. Alternatively, or additionally, it is possible to monitor a user's activity levels by measuring the activity of the user using an accelerometer or a GPS sensor (e.g. if the system 100 is provided in smartphone) and recording average activity levels or walking distances in a day etc.

While selecting both the obtrusive and unobtrusive variant of the monitoring parameter for activity would collect the most data, this will come at the cost of extra processing and power consumption (affecting battery life) of the device. Using a GPS sensor comes at the cost battery life on a portable device. Hence, for some users, e.g. with the P3 (Fighter) or P1 (Analyst) profile, it may be desirable to select the obtrusive variant of the monitoring parameter for activity level. The users with the P3 (Fighter) or P1 (Analyst) profiles may not object to the obtrusive questioning, and there will not be an unnecessary drain on battery life. Hence, in this example, for users with the P3 (Fighter) or P1 (Analyst) profiles, it may be desirable to select the obtrusive variant of the monitoring parameter for activity level

For the P4 (Sensitive) or P2 (Optimist) profiles, it may be that the obtrusive variant of the monitoring parameter for activity level would be ignored by the user, and so it is best to select the unobtrusive variant of the monitoring parameter for activity level, even though this may decrease the device battery life.

Furthermore, for some monitoring parameters (e.g. heart rate), the unobtrusive variant (e.g. remote heart rate measurement using a camera) is inherently less accurate than the obtrusive measurement. For example, if a camera on a smartphone forming the system 100 is attempting to capture information amount skin dilation and the user does not know this, then the user might move or put down the smartphone, causing the measurement opportunity to be lost. Hence, the selection of the most appropriate method of monitoring the parameter for the user is important.

Furthermore, some profile types respond better to subjective questioning than they do to objective measures. Users with the P2 (Optimist) profile will respond better to subjective questions regarding how they feel, rather than being asked to perform objective measurements. The opposite is true for those with the Analyst profile.

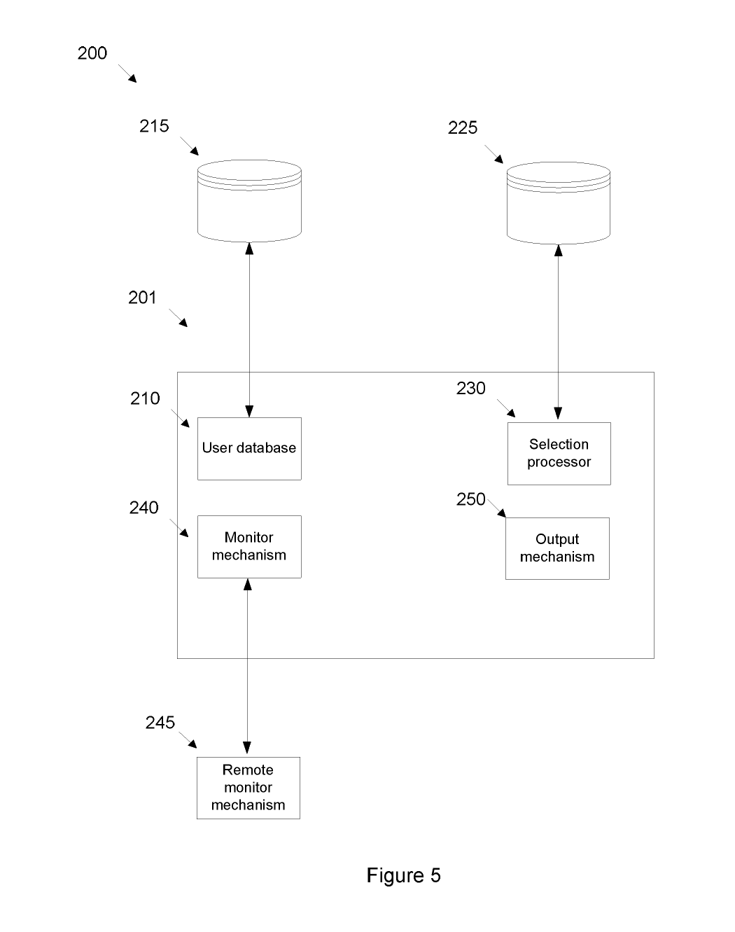

FIG. 5 schematically shows a system 200 for monitoring a user according to a second embodiment of the invention. In this embodiment, the system 200 is specifically arranged to monitor the user's adherence to a medication regime. As a result, the user in the context of this embodiment is a patent with a long term health condition that requires a medication regime into order to keep the user's long term health condition stable. In this example embodiment, it will be assumed that non-adherence with the user's medication regime will lead to a worsening of the patient's symptoms, possibly leading to an event onset.

The system 200 comprises a device 201 and a number of remote devices, including a remote profile database 215, a remote monitoring database 220 and a remote monitor mechanism 245. The device 201 comprises a user database 210, a selection processor 230, a monitor mechanism 240, and an output mechanism 250.

The device 201 is in communication with the remote profile database 215, the remote monitoring database 225 and the remote monitor mechanism 245 via suitable interfaces. For example, the device 201 could be connected to the remote profile database 215, and the remote monitoring database 225 via a network, such as the internet. The device 201 could be connected to the remote monitor mechanism 245 via a short range wireless connection, such as Bluetooth. It will, however, be appreciated that other embodiments could use other ways of connecting the remote devices to the device 201.

In this embodiment, the device 201 could be a portable device (e.g. a smartphone) or a standalone device. In other embodiments, the device 201 could be integrated into the functionality of a general purpose device.

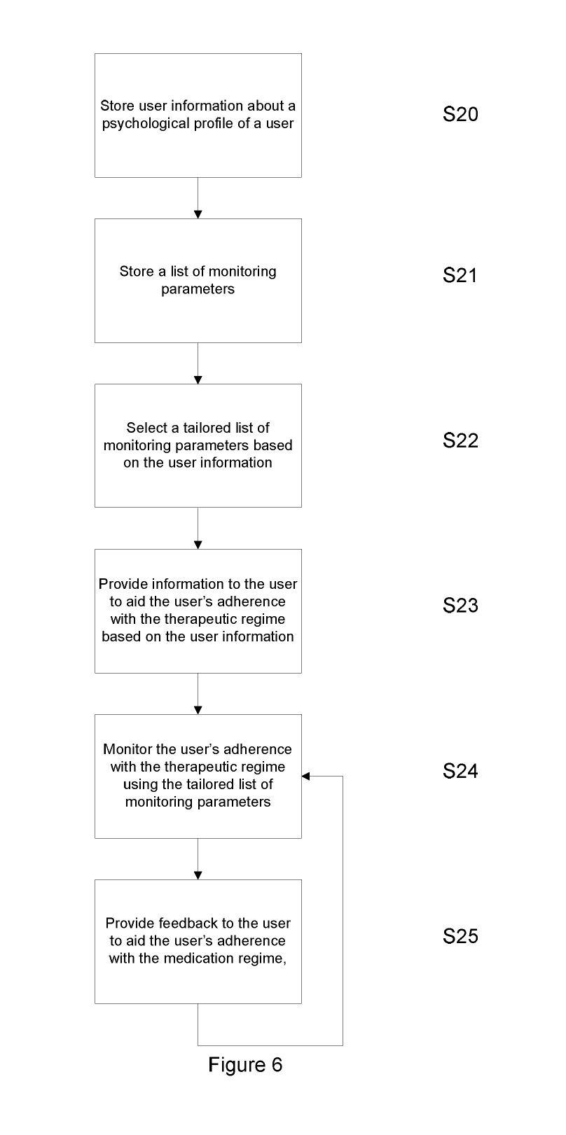

FIG. 6 shows a flow diagram explaining the operation of the system 200 monitoring the user's adherence to a medication regime.

In step S20 of FIG. 6, the system 200 stores user information about a psychological profile of a user in the user database 210. In this embodiment, the device 201 does not obtain the user information about a psychological profile of the user directly. Instead, the device 201 obtains this information from the remote profile database 215. For example, the remote profile database 215 could comprise a datastore at a health care provider, and the device 201 could access this datastore. In such an example, the user information about a psychological profile of the user could be obtained by the health care provider (or other external source). For ease of explanation of this embodiment, the system 200 determines the user information about a psychological profile of a user, by determining the user's profile as discussed in relation to FIG. 4. In other words, the user is categorised into one of the P1, P2, P3 or P4 profiles.

In step S21, the system 200 stores a list of monitoring parameters. In this embodiment, the device 201 does not store the full list of list of monitoring parameters. Instead, this list is stored on the remote monitoring database 225.

As this embodiment is specifically concerned with monitoring the user's adherence to a medication regime, the stored list of monitoring parameters may relate to those monitoring parameters (e.g. those selected from a master list of monitoring parameters that are suitable for monitoring the user's adherence to their medication regime). At step S22, the selection processor 230 of the system 200 selects a tailored list of monitoring parameters based on the user information. This could be done in the way discussed in relation to step S12 of FIG. 3, with the difference being that the device 201 selects the monitoring parameters from those stored in the remote monitoring database 225. The tailored list of monitoring parameters based on the user information would then be stored in memory (not shown) of the device 201.

At step S23, the output mechanism 250 provides information to the user to aid the user's adherence with the therapeutic regime. For example, the output mechanism 250 could provide a schedule for the user to read, showing when and how to follow their medication regime. In this embodiment, the information provided to the user to aid the user's adherence with the therapeutic regime is tailored based on the user information. Hence, in such embodiments, the form and content of the information display to the user is varied according to the user's psychological profile. By doing this the user is provided with information in a form and content that they are more likely to the understand information or interpret it correctly, and more likely to find information motivating. The user is also less likely to find the information discouraging, and less likely to feel threatened by the information with, greatly enhancing the usability of the system and user experience.

At step S24, the monitor mechanism 240 of system 200 monitors the user using the tailored list of monitoring parameters to provide monitoring results. It will be appreciated that the form of the monitoring will depend on the monitoring parameters present in the list tailored for the user. In this embodiment, the device 201 of the system 200 connects to a remote monitoring database 220 for at least part of the monitoring of the user. For example, the remote monitoring database 220 could comprise a blood pressure monitor.

It will be appreciated that adherence has two main components: perceptual and practical. For non-adherence, it is possible to distinguish accordingly between intentional and unintentional non-adherence. For the perceptual component of adherence it is possible to monitor perceived need to follow the therapy regime and/or level of user's concerns about the therapy regime. This could be achieved in the form of questionnaires for this purpose (e.g. BMQ—believes about medication questionnaire), applied in a way tailored for the individual profiles. For the practical component of adherence, it is possible to monitor a user's behaviour (e.g. % of cases when the user performs a certain behaviour).

At step S25, the output mechanism 250 provides feedback to the user to aid the user's adherence with the medication regime. After step S25, the method loops back to step S24.

In this embodiment, the form and content of the information provided to the user is also determined on the basis of the user information. In other words, in step S23 the information provided to the user is selected based on the psychological profile of the user. Furthermore, the form and content of feedback provided to the user to aid the user's adherence with the medication regime is also determined on the basis of the user information.

As an example, a user with the P1 profile could be provided a large number of things to track with more levels and regimented routine with detailed feedback.

A user with the P2 profile would be provided with expressive feedback (e.g. using smiley faces) that is not too frequent.

A user with the P3 profile would be provided with a clear report of progress via regular feedback according to monitoring parameters that are linked to goals. The system could employ a visual style of entry with information about a trend.

A user with the P4 profile would not be monitored using a routine, and would only be given negative feedback if it was clearly severe be provided a guidance how to perform the desired tasks (e.g. in a form of a checklist) and by indicating his progress along this guidance, the user will provide input for monitoring (behaviour monitoring).

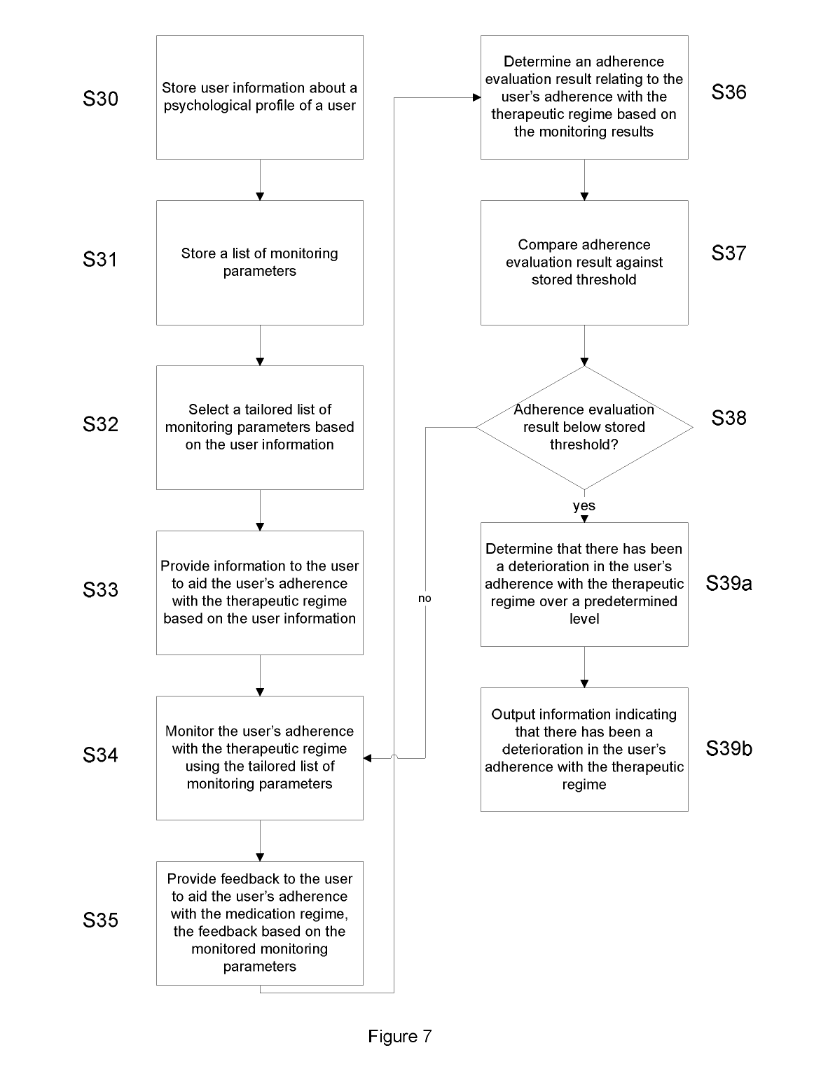

FIG. 7 shows a flow diagram explaining the operation of the system 200 monitoring the user's adherence to a medication regime according to another embodiment.

In FIG. 7, steps S30-35 are the same as steps S20-25, and so will not be discussed again. FIG. 7 differs from FIG. 6 in that after step S35, instead of the method looping back to step S34, the method moves to step S36.

In step S36, the system 200 determines an adherence evaluation result relating to the user's adherence with the therapeutic regime based on the monitoring results. It will be appreciated that the adherence evaluation result could be calculated in a number of ways, taking into account the two main components of adherence (i.e. perceptual and practical). For example, the system 200 could assign weights to different monitoring parameters (e.g. relating to the perceptual and practical components of adherence) to produce a combined result.

Then, in step S37, the system 200 compares the adherence evaluation result against a stored threshold.

At step S38, the system 200 determines whether the adherence evaluation result is below the stored threshold. If the adherence evaluation result is not below the stored threshold, then the method moves back to step S34, and the monitoring of the user continues.

If the adherence evaluation result is below the stored threshold, then the method moves to step S39a. At step S39a, the system 200 determines that there has been a deterioration in the user's adherence with the therapeutic regime over a predetermined level. In other words, the system 200 determines that the user is not adhering to the medication regime to a level that may become problematic to the other.

At step S39b, the system 200 outputs information indicating that there has been a deterioration in the user's adherence with the therapeutic regime. This could be via a suitable warning to the user via a display of the output mechanism 250, or the system 200 could automatically output a relevant message to a health care professional or other care provider that the user's adherence is not at the level it should be at.

Although the flow diagrams of FIGS. 6 and 7 have been explained in the context of the system 200 shown in FIG. 5, it will be appreciated that other embodiments of the system could use a different hardware configuration. For example, a number of the components of the system 200 that are described as being remote to the device 201 could be internal to the device. Alternatively, some of the functions of the device 201 could be handled by a remote device. In particular, it is noted that the hardware configuration of FIG. 2 could be used with the flow diagrams of FIGS. 6 and 7. Furthermore, although one remote monitor mechanism is shown, it will be appreciated that some embodiments of the invention may use several such remote monitor mechanisms.

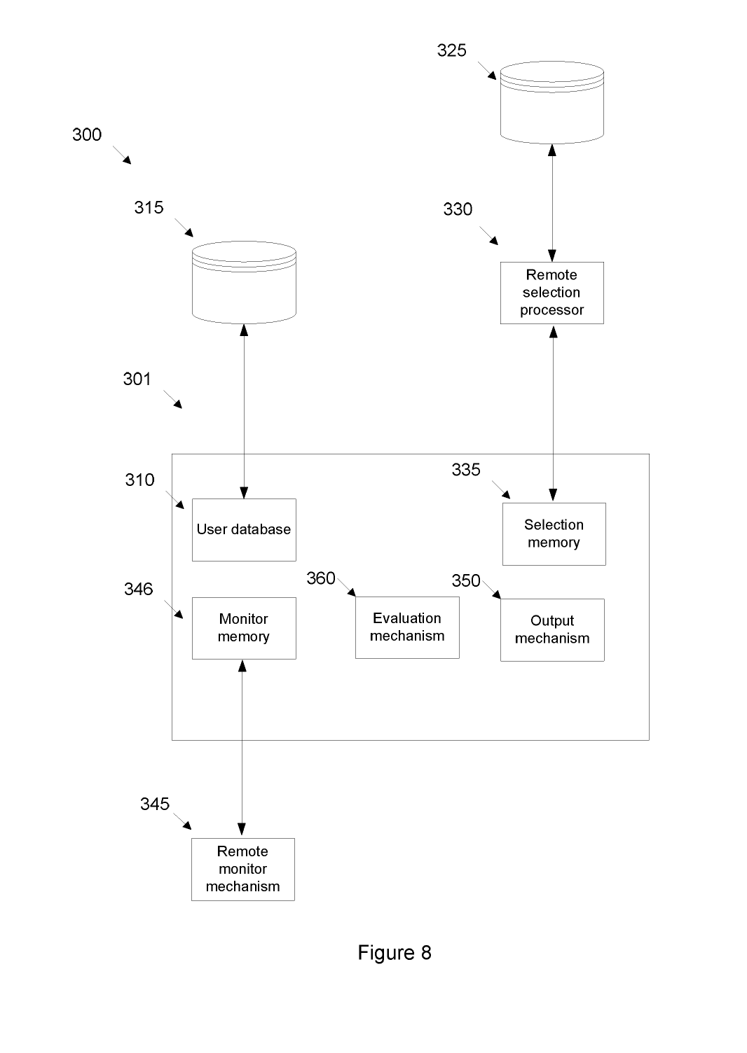

FIG. 8 schematically shows a system 300 for monitoring a user according to a third embodiment of the invention. In this embodiment, the system 300 is specifically arranged to monitor the user's health, with the aim of measuring when the user's health deteriorates beyond a certain level. As a result, the system 300 can be used to detect an event onset. The event could be triggered by the patient contracting another illness (e.g. a cold) or by some other cause that worsens the patient's condition (e.g. non-adherence to the user's medication regime). As a result, the user in the context of this embodiment is a patent with a long term health condition that desires to keep their long term health condition stable.

The system 300 comprises a device 301 and a number of remote devices, including a remote profile database 315, a remote selection processor 330 connected to remote monitoring database 325, and a remote monitor mechanism 345. The device 301 comprises a user database 310, a selection memory 335, a monitor memory 346, and an output mechanism 350.

The device 301 is in communication with the remote profile database 315, a remote selection processor 330, and a remote monitor mechanism 345 via suitable interfaces. For example, the device 301 could be connected to the remote profile database 315, and the remote selection processor 330 via a network, such as the internet. The device 301 could be connected to the remote monitor mechanism 345 via a short range wireless connection, such as Bluetooth. It will, however, be appreciated that other embodiments could use other ways of connecting the remote devices to the device 301.

In this embodiment, the device 301 could be a portable device (e.g. a smartphone) or a standalone device. In other embodiments, the device 301 could be integrated into the functionality of a general purpose device.

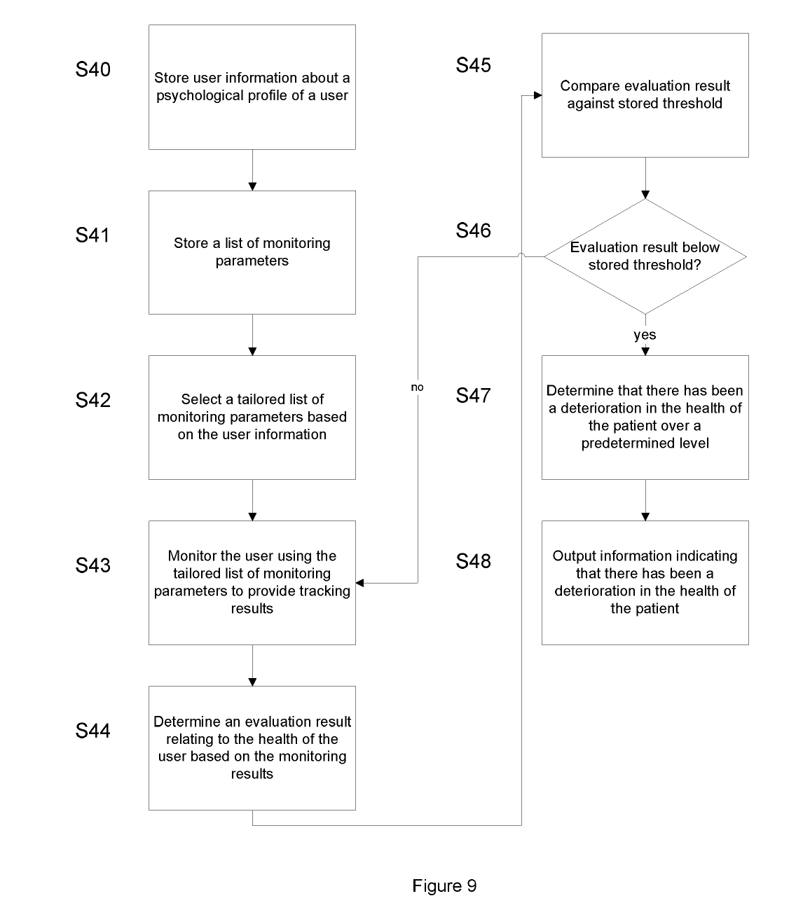

FIG. 9 shows a flow diagram explaining the operation of the system 300 monitoring the user's adherence to a medication regime.

In step S40 of FIG. 9, the system 300 stores user information about a psychological profile of a user in the user database 310. In this embodiment, the device 301 does not obtain the user information about a psychological profile of the user directly. Instead, the device 301 obtains this information from the remote profile database 315, in a similar way to that as described in relation to FIG. 5.

In step S31, the system 300 stores a list of monitoring parameters. In this embodiment, the device 301 does not store the full list of list of monitoring parameters. Instead, this list is stored in the remote monitoring database 325. Furthermore, as this embodiment is specifically concerned with monitoring the user's health condition, the stored list of monitoring parameters would relate to those monitoring parameters (e.g. those selected from a master list of monitoring parameters) that are suitable for monitoring the particular long term health condition of the user.

At step S42, the remote selection processor 330 of the system 300 selects a tailored list of monitoring parameters based on the user information. This could be done in the way discussed in relation to step S12 of FIG. 3. For ease of explanation of this embodiment, the system 300 determines the user information about a psychological profile of a user, by determining the user's profile as discussed in relation to FIG. 4. In other words, the user is categorised into one of the P1, P2, P3 or P4 profiles. The remote selection processor 330 of the system 300 provides the tailored list of monitoring parameters to the device 301 for storage in the selection memory 335.

At step S43, the remote monitor mechanism 340 of system 300 monitors the user using the tailored list of monitoring parameters to provide monitoring results. It will be appreciated that the form of the monitoring will depend on the monitoring parameters present in the user's tailored list. In this embodiment, the remote monitor mechanism 340 provides results of the monitoring to the monitor memory 346.

As step S44, the evaluation mechanism 360 of the system 300 is arranged to determine an evaluation result relating to the health of the user based on the monitoring results. It will be appreciated that the evaluation result could be calculated in a number of ways. For example, the system 300 could assign weights to different monitoring parameters to produce a combined result.

Then, in step S45, the evaluation mechanism 360 compares the evaluation result against stored threshold. At step S46, the evaluation mechanism 360 determines whether the evaluation result is below the stored threshold. If the adherence evaluation result is not below the stored threshold, then the method moves back to step S43, and the monitoring of the user continues.

If the evaluation result is below the stored threshold, then the method moves to step S47. At step S47, the evaluation mechanism 360 determines that there has been a deterioration in the user's health over a predetermined level. In other words, the evaluation mechanism 360 determines that the user's condition to a level that may be or at least become problematic.

At step S48, the system 300 outputs information indicating that there has been a deterioration in the health of the user. This could be via a suitable warning to the user via a display of the output mechanism 350, or the system 300 could automatically output a relevant message to a health care professional or other care provider that the user's health has deteriorated.

The advantages of such arrangements is a higher probability that the patient responds to the deterioration of the health state early, when the chances of effective intervention at home are still high. In some embodiments, the system can be also configured to warn directly the user (patient) if the patient is able and willing to respond to the warning in a reliable way. If the patient is considered not reliable to respond to the warning or if patient's response to the warning is not detected, the system can warn a care provider.

Although the flow diagram of FIG. 9 has been explained in the context of the system 300 shown in FIG. 8, it will be appreciated that other embodiments of the system could use a different hardware configuration. For example, a number of the components of the system 300 that are described as being remote to the device 301 could be internal to the device. Alternatively, some of the functions of the device 301 could be handled by a remote device. Furthermore, although one remote monitor mechanism is shown, it will be appreciated that some embodiments of the invention may use several such remote monitor mechanisms.

To help explain the embodiments of the invention further, a number of specific examples will now be discussed.

### Example 1

### Congestive Heart Failure

Congestive heart failure (CHF) is an inability of the heart to provide sufficient pump action to distribute blood flow to meet the needs of the body. CHF can cause a number of symptoms including shortness of breath, leg swelling, and exercise intolerance. Treatment for CHF commonly consists of lifestyle measures such as smoking cessation, light exercise including breathing protocols, decreased salt intake and other dietary changes, and medications. Sometimes it is treated with implanted devices (pacemakers or ventricular assist devices) and occasionally a heart transplant.

As such, CHF represents an example of a long term health condition that can benefit from monitoring, both of the health of the user and of the user's adherence to their therapeutic regime.

For CHF the critical medications are typically beta blockers and diuretics. If these are being taken correctly (i.e. according to the user's therapeutic regime), then the user has the best chance of remaining stable with CHF. However, not taking the beta blockers can lead to arrhytmias, and not taking the diuretics can lead to lung edema. Both of these conditions can be life threatening and may require hospitalization. They are generally called “CHF decompensation”.

In this embodiment, a patient monitoring system according to an embodiment of the invention aims to identify onset of de-compensation of a patient with CHF. The CHF de-compensation is accompanied with lung edema. Early pharmacological intervention can reduce the amount of fluid accumulated in the patient's chest and prevent acute event, requiring ER visit or hospitalization.

Suitable monitoring parameters for a patient monitoring system according to an embodiment of the invention that aims to identify onset of de-compensation of a patient with CHF are:

M1: chest impedance using a vest
M2: (increase of) weight as a sign of fluid accumulation using a scale
M3: dyspnea as a symptom accompanying lung edema using a subjective questionnaire
M4: (decrease of) activity level as a behavioural response to dyspnea measured by an accelerometer
M5: daily activities elicitation through guided dialogue
M6: feelings questionnaire
M7: self-management behaviour (performance of activities from the self-management plan) by means of an interactive checklist

Hence, M1-M7 provide a complete set of set of monitoring parameters for CHF. The characteristics of such monitoring parameters are:

M1: objective, needs effort, sophisticated, needs special medical device, disease related
M2: objective, less accurate than M1, standard device, low effort, easy to use, not disease related
M3: subjective, disease related, medium effort (measuring during the day)
M4: objective, effortless, not disease related, special consumer device (small, light), low specificity, needs to be combined with context information
M5: subjective, disease focus can be avoided, medium effort, opportunity for social interaction (can be done together with a partner)
M6: subjective, low effort, not disease specific
M7: subjective, low effort, disease specific

The characteristics of each profile type P1, P2, P3, and P4 have been discussed above. A tailored list of these monitoring parameters for each profile type for CHF is provided below:

Tailored list for P1 (Analyst): M1, M2, M3, M4
Tailored list for P2 (Optimist): M4, M5
Tailored list for P3 (Fighter): M1, M4, M7
Tailored list for P4 (Sensitive): M2, M4, M6, M7

The reasons why these tailored lists are chosen for each profile will now be discussed.

For the P1 (Analyst) profile, performing effortful routines will make the Analyst feel in control. In addition, usage of a sophisticated medical device and state of the art precision of measurement will make him feel like an expert. In addition, using a variety of monitored parameters will satisfy Analyst's hunger for information. Such a combination shall ensure, that the Analyst stays focused on self-management. M4 (if the user desires more involvement).

For the P2 (Optimist) profile sharing subjective feeling in a social setting (i.e. M5—which would be enjoyable for Optimist) is a typical enjoyable activity of the Optimist and at the same time yields important input for correct interpretation of the totally unobtrusive activity level monitoring. A Further advantage of the approach is that it does not explicitly confront the Optimist with the disease (M4 is effortless, and not disease related).

For the P3 (Fighter) profile, the M1 and M4 monitoring provides an objective trend information, that can be turned into a clear goal and an actionable advice. M1 is the main deterioration detection mechanism here, while M4 is mainly used to keep the monitoring actionable and relevant for the Fighter over a long period of time. Interactive checklist M7 provides the Fighter with a sense of accomplishment.

For the P4 (Sensitive) profile, the combination of objective and subjective monitoring can create a secure feeling for the Sensitive person, that he is being accurately monitored. Interactive checklist provides reassurance that all the steps in the daily routine were done. Usage of non-medical devices, like scale, reduces anxiety of the Sensitive person and improves ease of use.

### Example 2

### Chronic Obstructive Pulmonary Disease

Chronic obstructive pulmonary disease (COPD) is the occurrence of chronic bronchitis or emphysema, a pair of commonly co-existing diseases of the lungs in which the airways become narrowed. This leads to a limitation of the flow of air to and from the lungs, negatively impacting gas exchange and causing shortness of breath (dyspnea).

For COPD the daily oral medication is complemented by daily inhalation medication (long-acting bronchodilators with steroids), symptom based inhalation medication (short acting bronchodilators) used in case of shortness of breath and for severe cases with oxygen therapy and non-invasive ventilation.

Not taking bronchodilators leads to shortness of breath and higher sensitivity of the lung tissues to infections and external stimuli, leading further to COPD acute exacerbation, requiring an emergency room visit. Roughly 30% of those emergency room visit result in the hospitalisation of the patient, with roughly 10% of those hospitalisations being mortal.

Not using oxygen therapy leads to hypoxemia or hypercapnia, which could cause loss of consciousness, irreversible damage of brain cells or respiratory failure. The latter always requiring hospitalization and highly mortal, the former two very dangerous and having long term irreversible effect on quality of life.

For COPD the typical monitoring parameters are dyspnea, levels of coughing, amount and colour of sputum, tiredness, and SpO2 (blood oxygenation) for more severe cases. It will be appreciated how an appropriate tailored list of these monitoring parameters can be chosen to suit each of the P1, P2, P3 and P4 profiles.

### Example 3

### Crohn's Disease

Crohn's disease is an autoimmune disease, and patients typically take oral medication. A contemporary and very powerful treatment involves biologics, which have to be (self-) injected typically every two to three weeks. Failure to do so, i.e. longer gaps between injections or stopping the injection in symptom-free periods leads to reactivation of the disease as a result of excessive TNF-alpha particles in blood causing inflammatory reactions of sensitive body tissues. This causes the affected body parts (for Crohn's disease these are intestines) to be gradually damaged by the inflammation and lose their function, requiring surgical intervention.

For Crohn's disease the typical monitoring parameters are pain, gas, blood in stools, diarrhoea, and tiredness. It will be appreciated how an appropriate tailored list of these monitoring parameters can be chosen to suit each of the P1, P2, P3 and P4 profiles.

As discussed, embodiments of the invention provide a system for monitoring a user, comprising: a user database arranged to store user information about a psychological profile of the user; a monitoring database arranged to store a set of monitoring parameters, each monitoring parameter comprising a measurable parameter related to the user; a selection processor arranged to select a tailored list of monitoring parameters from the set of monitoring parameters based on the user information; a monitor mechanism arranged to monitor the user using the tailored list of monitoring parameters to provide monitoring results; and an output mechanism arranged to output information related to the monitoring results.

Such embodiments provide the advantage that the monitoring of the user (e.g. monitoring the health of the user or the user's adherence to a medication regime) is done using monitoring parameters that are compatible with and appropriate for the psychological profile of the user. People can be categorised according to their psychological profile, with different people responding better or worse to the same means of monitoring them. In addition, the form and/or content of the information display to the user is varied according to the user's psychological profile. By doing this the user is provided with information in a form and/or content that they are comfortable with, greatly enhancing the usability and user experience of the system. As a result, the user is more likely to understand the information and interpret it correctly, and is more likely to find information motivating. The user is also less likely to find the information discouraging, and less likely to feel threatened by the information.

Hence, embodiments of the invention provide an improved system and method for monitoring a user. Such a system provides greatly enhanced monitoring by tailoring the monitoring (and in some cases the feedback of the monitoring) to the psychological profile of the user. It has been found that such arrangements are a significant improvement on known systems that provide the same monitoring methods for all users (with the benefit being comparable to the difference between using or not using the system).

It will be appreciated that the hardware used by embodiments of the invention can take a number of different forms. For example, all the components of the system could be provided by a single device (e.g. the example of FIG. 2), or different components of the system could be provided on separate devices. Examples of such arrangements are the systems of FIGS. 5 and 8, in which a number of the components of the respective systems are provided on a device, whereas other components are provided on remote devices (with “remote” in this context meaning not part of the device, but communicable with the device). More generally, it will be appreciated that embodiments of the invention can provide a system that comprises one device or several devices in communication.

It will be appreciated that the term “comprising” does not exclude other elements or steps and that the indefinite article “a” or “an” does not exclude a plurality. A single processor may fulfil the functions of several items recited in the claims. The mere fact that certain measures are recited in mutually different dependent claims does not indicate that a combination of these measures cannot be used to an advantage. Any reference signs in the claims should not be construed as limiting the scope of the claims.

Although claims have been formulated in this application to particular combinations of features, it should be understood that the scope of the disclosure of the present invention also includes any novel features or any novel combinations of features disclosed herein either explicitly or implicitly or any generalisation thereof, whether or not it relates to the same invention as presently claimed in any claim and whether or not it mitigates any or all of the same technical problems as does the parent invention. The applicants hereby give notice that new claims may be formulated to such features and/or combinations of features during the prosecution of the present application or of any further application derived therefrom.

1. A system for monitoring a user, the system comprising:
a user database arranged to store user information relating to a psychological profile of the user;
a monitoring database arranged to store a set of monitoring parameters, each monitoring parameter comprising a measurable parameter related to the user;
a selection processor arranged to select a tailored list of monitoring parameters from the set of monitoring parameters based on the user information;
a monitor mechanism arranged to monitor the user using the tailored list of monitoring parameters to provide monitoring results; and
an output mechanism arranged to output information related to the monitoring results.

2. A system according to claim 1, wherein the user information comprises information relating to which of a predetermined number of psychological profiles the user belongs to, with each said psychological profile being differently responsive to certain monitoring parameters.

3. A system according to claim 1, wherein the output mechanism is arranged to display information used in the monitoring of the user using the tailored list of monitoring parameters.

4. A system according to claim 1, wherein the output mechanism is arranged to display feedback to the user regarding the results of the monitoring.

5. A system according to claim 3, wherein the output mechanism is arranged to select the appropriate information to display based on the user information.

6. A system according to claim 3, wherein the output mechanism is arranged to tailor how to display the information to the user based on the user information.

7. A system according to claim 1, wherein the monitor mechanism is arranged to monitor the user's adherence with a therapeutic regime using the tailored list of monitoring parameters, wherein the output mechanism is arranged to display feedback to the user to aid the user's adherence with the therapeutic regime.

8. A system according to claim 7, wherein the monitor mechanism is arranged to determine an adherence evaluation result relating to the user's adherence with the therapeutic regime based on the monitoring results, and to determine based on a comparison of the adherence evaluation result compared to a stored adherence evaluation result threshold whether there has been a deterioration in the adherence of the user to the therapeutic regime over a predetermined threshold.

9. A system according to claim 8, wherein if there has been a deterioration in the adherence of the user to the therapeutic regime over the predetermined threshold, the output mechanism is arranged to provide an appropriate adherence alert, that there has been such a deterioration in the adherence of the user to the therapeutic regime.

10. A system according to claim 9, wherein the output mechanism is arranged to tailor the adherence alert based on the user information.

11. A system according to claim 1, further comprising:
an evaluation mechanism arranged to determine an evaluation result relating to the health of the user based on the monitoring results, and to determine based on a comparison of the evaluation result compared to a stored evaluation result threshold whether there has been a deterioration in the health of the patient over a predetermined threshold.

12. A system according to claim 11, wherein if there has been a deterioration in the health of the patient over the predetermined threshold, the output mechanism is arranged to provide an appropriate alert, that there has been such a deterioration.

13. A system according to claim 12, wherein the output mechanism is arranged to tailor the alert based on the user information.

14. A system according to claim 1, wherein the user information further comprises information relating to additional information about the user, and wherein the selection processor is arranged to select a tailored list of monitoring parameters from the set of monitoring parameters taking into account said additional information about the user.

15. A method for monitoring a user, the method comprising:
storing user information relating to a psychological profile of the user;
storing a set of monitoring parameters, each monitoring parameter comprising a measurable parameter related to the user;
selecting a tailored list of monitoring parameters from the set of monitoring parameters based on the user information;
monitoring the user using the tailored list of monitoring parameters to provide monitoring results; and
outputting information related to the monitoring results.
